(19) United States
(12) Patent Application Publication
(10) Pub. No.: US 2013/0134254 A1
(43) Pub. Date: May 30, 2013

(54) UAV Fire-fighting System

(71) Applicant: Jason Moore, Aberdeen, MD (US)

(72) Inventor: Jason Moore, Aberdeen, MD (US)

(21) Appl. No.: 13/306,419

(22) Filed: Nov. 29, 2011

(51) Int. Cl. B64C 27/00; A62C 99/00; B64C 39/02

(52) U.S. Cl. 244/17.11

(57) ABSTRACT

An unmanned aerial vehicle (UAV) designed to extinguish fires from the air while remaining tethered to the ground via a tether system fashioned to provide the UAV with power and extinguishant. The UAV is preferably electrically powered and is stabilized in the air via a system of gyroscopes fashioned to work in concert with a series of electric motors capable of moving to counteract the opposing recoil force exhibited as water escapes the nozzle of the tether. A command and control unit on the ground supplies the UAV with electricity and water via the tether. The UAV is preferably stored within and launched from the command and control unit. Controls and sensor readings are communicated to a controller—be it autonomous or human—on the ground, preferably within or proximal to the command and control unit.

### FIELD OF THE PRESENT INVENTION

The present invention relates to unmanned aerial vehicles (UAV), and more specifically to UAVs equipped to extinguish fires. Existing firefighting UAV's employ a reservoir tank for extinguishant, with the extinguishant released over the fire area. The present invention, however, employs a fire hose attached to a water source on the ground, and releases the extinguishant via the hose nozzle mounted on the UAV, onto the flame's fuel.

### BACKGROUND OF THE PRESENT INVENTION

Though our society continues to progress, advance, and grow, natural disasters or unforeseen accidents continue to occur occasionally. One of the most devastating elements of nature to mankind's growth and prosperity is fire, as its ability to spread quickly and engulf entire forests and buildings rapidly make it one of nature's deadliest forces. While fire-retardant building materials and coatings have advanced mankind's capacity to prevent a fire, fires still occur. Cooking accidents, campfire, or firework accidents, each often influenced by combustible materials, are still likely to occur. Fire education and safety are still the best means of defense against a fire; yet, despite early, sufficient safety education, fires will continue to occasionally occur as a natural phenomenon.

As mankind has advanced, there have been many different technologies designed for fighting fires and extinguishing them rapidly. Conventional fire hoses and fire trucks are commonly deployed to the scene of a fire, and are outfitted with a team of firefighters, trained to handle the hazardous situation. In cases where a fire has spread, often to multiple buildings, or to adjacent acres of forest land or other dry, commonly wooded or dry land, aerial reinforcements such as helicopters and airplanes are commonly called upon to release water and fire-retardant chemicals onto a fire area, as are unmanned aerial vehicles (UAVs), in an attempt to snuff out the fire. In the case of UAVs, tanks of extinguishant, commonly a form of powder, such as sodium bicarbonate, potassium bicarbonate, or monoammonium phosphate, are attached to the UAVs and dispersed over the flame's fuel. These chemicals effectively coat the fuel of the fire in order to smother and extinguish the fire.

Extinguishing fires in remote, inaccessible areas is a task that demands a high-tech, premeditated response, as travel time to the region in danger may be extensive. In hazardous areas, such as a breakout fire at a chemical or power plant, getting to the fire safely can be a challenge itself. In these cases, often aerial units are of the first responders to arrive on the scene. Conventional aerial fire fighting units such as planes and helicopters carry a static amount of water or chemical solution on board, occupying much of the vehicle's payload. Unfortunately, once these units have depleted their supply of extinguishant, they must return to refuel and resupply with more extinguishant, then return to the scene of the fire. In cases where the fire is in a remote area of the country, this can mean several minutes or even an hour may pass before the same vehicle completes one round trip. If there were a way to prevent the need to resupply the UAV, or a method by which extinguishant may be constantly supplied to the aerial unit while dispersing extinguishant simultaneously, fires would have less unattended time to grow, translating to a greater likelihood of expediently extinguishing the fire in a timely fashion.

Thus, there is a need for an aerial fire extinguishing unit capable of receiving a steady supply of extinguishant from an external source, such as from the ground, or another aircraft, while simultaneously dispersing the extinguishant in order to expedite the cessation of a fire, especially in remote areas of the country.

U.S. Pub. No. 2009/0205845 for “System and Method for Extinguishing Wildfires” by Hoffman, published on Aug. 20, 2009, shows a UAV loaded onto a transport aircraft and carried near a fire area, at which point the UAV is launched and releases fire extinguishing or fire retardant material from the UAV onto the fire or anticipated fire path. Unlike the present invention, Hoffman does not use a source of extinguishant external to the UAV.
U.S. Pat. No. 7,121,353 for “Airborne Vehicle for Firefighting” by Setzer, issued on Oct. 17, 2006, shows an airborne vehicle equipped with an extinguishant container that is deployed and detonated over a fire. Unlike the present invention, Setzer does not employ a UAV nor a fire hose.
U.S. Pat. No. 7,836,965 for “Method and Device for Controlling and/or Putting Out Fires” by Korenkov et al., shows a container with fire-extinguishing agent that is launched toward a fire from an airplane. Unlike the present invention, Korenkov et al. does not employ a UAV nor a firehose connected to same.
U.S. Pat. No. 6,470,805 for “Fire Retardant Bio-Friendly Practice Munition” by Woodall et al, published on Oct. 29, 2002, shows munitions fitted out with fire retardant that are dropped on wildfires. Unlike the present invention, Woodall et al. does not mention UAVs or utilizing a fire hose in conjunction with same.

### SUMMARY OF THE PRESENT INVENTION

The present invention is an unmanned aerial vehicle (UAV) specially outfitted with the capacity to expel water or other fire retardant chemicals from an equipped nozzle, similar to those found on conventional fire hoses, only preferably slightly smaller. The preferred embodiment of the present invention is configured to remain in the air while water or fire retardant chemicals are propelled, via pressure, to the fire below. In order to maintain flight, the present invention requires a sophisticated stability system, engineered to counteract the opposing force of the pressure experienced as water or other chemicals are projected out of the nozzle on the present invention. The present invention is envisioned in an assortment of embodiments, however it is preferable that all embodiments of the present invention feature gyroscopic stabilization as well as specifically placed rotors, fashioned to spin at a velocity and angle in tandem with and in opposition to the GPM rate of the projected water or chemical retardant. Accordingly, the hose acts as a tether for the UAV, and supplies water, as well as electricity to power the UAV flight motors. The hose is then connected to a control module, which acts as a launching pad for the UAVs. In some embodiments, the command and control unit may be equipped with a water tank, or it may simply be outfitted to accept nearby water supplies, such as hydrants. The command and control unit also preferably houses the control platform employed to fly and direct the UAV from the ground.

The preferred embodiment of the present invention is equipped with at least one gyroscopic stabilizer, as well as a multidirectional set of rotors or rotary blades affixed to the tail of the UAV, designed to function at an angle opposing the hose nozzle direction, in order to attempt to compensate for the back pressure from the water escaping the hose in tow, at a high velocity. Therefore, the nozzle positioning is either static on the present invention, or, in some embodiments of the present invention, adjustments to the nozzle's spray direction must be in tandem with adjustments to the rear counter-balancing rotor. Similarly, if the pressure of the water is increased in order to attempt to extinguish the fire faster, the speed of the rotor blades must also be increase to counter the increased pressure pushing the present invention away from the fire. The counter forces present by the high velocity of the escaping water exiting the hose nozzle mounted on the present invention require these items for the present invention to functionally remain aloft.

It is the intent of the present invention to remain aloft until all flames are extinguished, or until the fire is firmly under control. Therefore, it is best that the present invention employ electronic motors capable of maintaining the UAV aloft in the air while remaining powered preferably via a source on the ground, or at the least, external to the UAV. In this light, the UAV will not require refueling. It is envisioned that the present invention will be equipped with a backup battery system as well, to be used in the event of an emergency, such as if the tether were severed.

Additionally, safety features are envisioned to be incorporated into the design of the UAV, including but not limited to, a parachute system, an air bag system, rotor covers (cages), and an emergency brake system, all preferably only employed in the event of a crash, or unless commanded by the controller. The controller is preferably an individual on the ground, who operates the UAV via remote thermal sensors housed within a sensory array, and a camera attached to the UAV, as well as navigational controls. The feeds from the sensor array, navigation, and camera(s) are preferably carried down the tether as well, although they could be wirelessly transferred to the controller at the command and control station as well, by using conventional wireless network technology.

By maintaining the central launch point of the UAVs at the command and control unit, the UAV has the benefit of employing a multi-stage regulator system housed in the command and control vehicle, which regulates the water pressure. The nozzle on the UAV is configured to propel any form of water mixture—pure water, foam, or any other medium that is used to fight fires, neutralize hazard materials or cool reactors.

Subsequently, the preferred embodiment of the present invention is designed to have a fire hose attached to it, such that the UAV can fly over the flames of the fire, or hover near it, and disperse extinguishant onto it. The other end of the fire hose will be attached to a source of extinguishant not located on the UAV itself, such as sources located on the ground (hydrants), on another aircraft, or on another vehicle on the ground.

The present invention is outfitted to be launched from vehicles equipped with a control station and launching system, referred to as a command and control unit. Ideally, the present invention is tethered to the command and control unit and/or water tank trucks arriving on the scene in the event that the fire is in a remote location or a location without a nearby fire hydrant.

### A BRIEF DESCRIPTION OF THE DRAWINGS

FIG. 1 displays the preferred layout of the primary rotors of the UAV of the present invention as viewed from the top.

FIG. 2 shows the layout the preferred embodiment of the present invention as viewed from below.

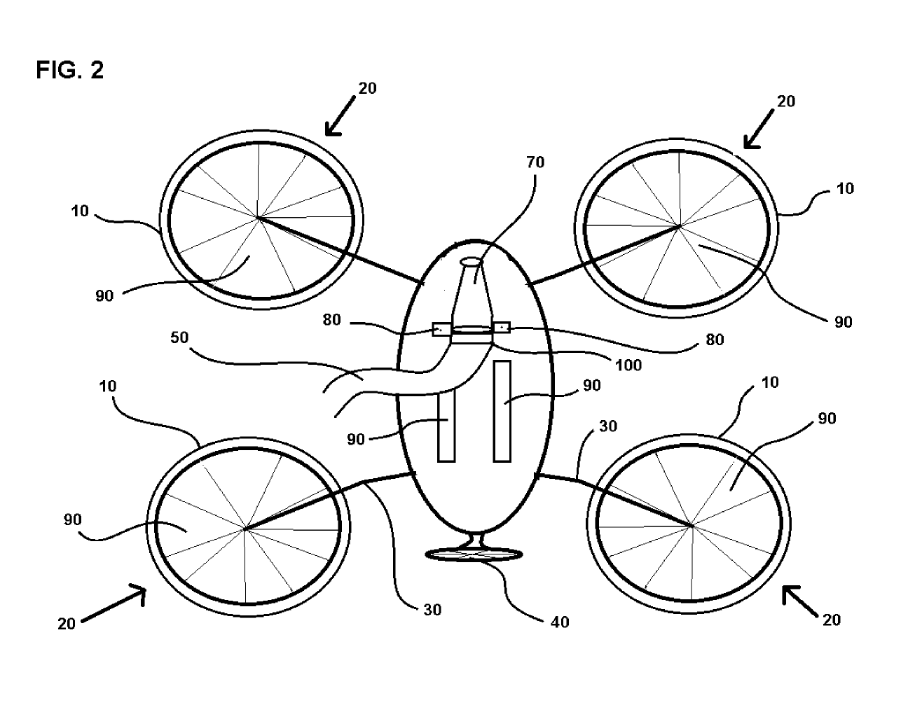

FIG. 3 exhibits a flow chart showing the path of water used to extinguish a fire via the present invention.

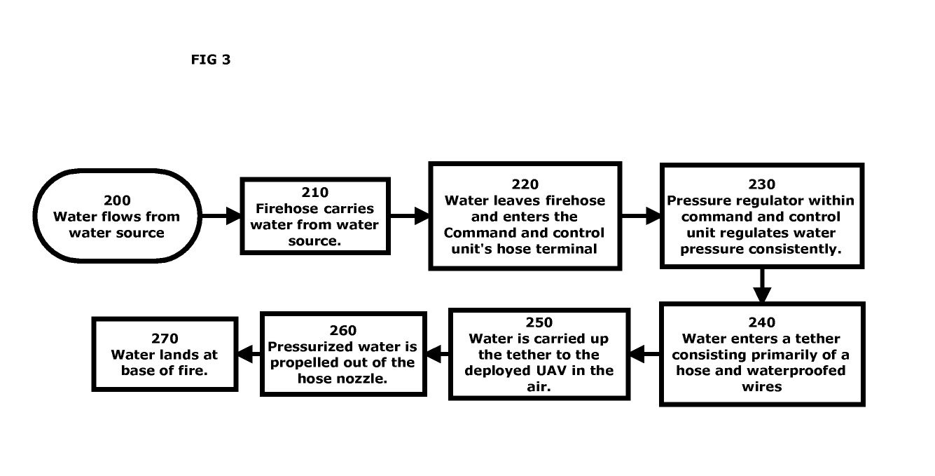

FIG. 4 details an alternate embodiment of the system of the present invention.

### DETAILED DESCRIPTION OF THE PRESENT INVENTION

The present invention, a fire-fighting UAV system, is configured to deploy UAV(s) (120) from a mobile command and control unit, in order to extinguish fires from the air while remaining aloft for the entire required duration. The present invention accomplishes this feat via a tether (50), connecting the UAV to the command and control unit on the ground. The tether (50) supplies the UAV (120) with electricity, which powers the at least one electric motor (20) designed to enable the UAV (120) to hover while remaining stable. In the preferred embodiment of the present invention, there are preferably four electric motors (20), although additional motors may be employed to aide with stability. Additionally, the tether (50) transports the water or other fire-retardant chemicals, which travel up a hose within the tether (50), and escape at a high velocity onto the fire from a hose nozzle (70) preferably affixed to the UAV (120) itself. The UAV (120) is specifically designed to remain aloft while spraying the fire with water from a high pressure hose in a stable fashion. The present invention preferably employs at least one gyroscope within the body of the UAV (120) in order to maintain stability in the air while projecting water on to flames. It is envisioned that multiple types of high pressure hoses can be adapted to function effectively with the tether (50) of the UAV (120).

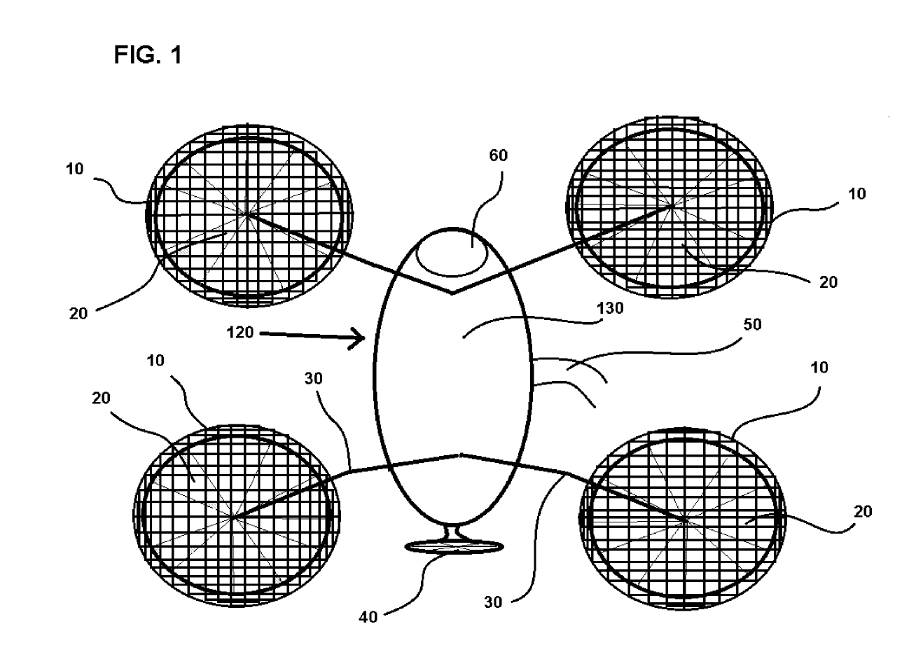

The present invention, has a main body (130) to which the electric motor(s) (20) are affixed. The at least one gyroscope is preferably housed within the body (130) of the present invention. The present invention is equipped with preferably at least four independent rotors, each driven by a conventional electric motor (20), as seen in FIG. 1. The blades (90) of the rotors driven by the electric motor(s) (20) are preferably fixed in rotation, however, it can be envisioned that the rotors themselves may rotate independently in order to adjust the thrust of each rotor assembly slightly. This could be prudent in situations with variable winds, which may make it difficult for the controller to effectively pilot the UAV (120).

The present invention includes the use of a command and control unit, which provides an outlet for controlling the various operations of the present invention. It is envisioned that the command and control unit may simply be a specially outfitted, conventional fire truck that, rather than deploying firefighters on the ground with hoses, instead deploys fire fighting UAVs equipped with hoses within a tether (50). The command and control unit serves as the launching and docking point for the present invention. Similarly, the command and control unit preferably serves as a housing and storage facility for the UAV(s) (120), which are preferably stored in a dedicated compartment within the command and control unit when they are not in use, in serviced, or being cleaned. The command and control unit is preferably equipped with launching bays which enable the UAV(s) (120) to easily be launched at the will of the controller, preferably operating the UAV(s) (120) from within the command and control unit on the ground, or similarly nearby, via a remote control.

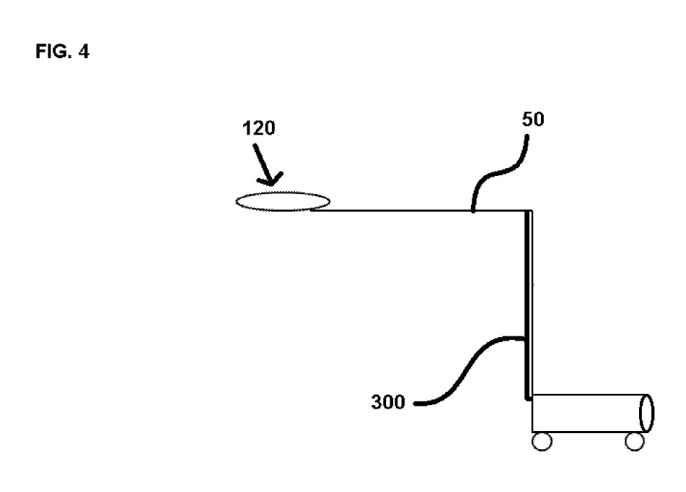

The UAV fire-fighting system requires a water delivery system that functions to regulate the pressure of the water, such that it remains consistent, and does not cause a sudden change of pressure, causing instability of the UAV (120). It is envisioned that a conventional fire hose, often connected to a conventional fire hydrant, would be connected to the command and control unit. Within the command and control unit, the water will be routed through a conventional pressure regulator, which ensures that the PSI of the water does not surpass the capacity of the at least one electric motor (20) to counter, keeping the UAV (120) aloft. From the conventional pressure regulator preferably found within the command and control unit, the water is then routed to the UAV(s) (120) via a hose encased within the tether (50). The tether is preferably secured to the UAV (120) via a mount (80). A water pump is used to overcome the gravitational forces exerted on the water as it is pumped upward, against gravity, into the air. In alternate embodiments of the present invention, a boom (300) may be employed to assist the in the elevation of the tether to the UAV (120), given as the tether, when in use, is envisioned to be quite heavy. The basic implementation of a boom (300) may be found in FIG. 4.

The sensor array (60) on the present invention are preferably located at the forefront of the UAV (120) system. The sensor array (60) should preferably include thermal sensors to detect the hottest portion of the fire, which may assist the controlling individual in determining the best points to direct water or other extinguishant onto the fire. Other sensors within the sensory array (60) may include an altimeter, so that the operator piloting the UAV (120) via remote control is aware of the height of the UAV (120). The sensor array (60) also preferably includes cameras, including but not limited to a night-vision camera, providing a live video feed to the operator on the ground via the tether.

The at least one electric motor (20) is preferably protected with rubberized bumpers on the perimeter and safety cages (10) above and below the blades (90) of the rotors. The safety cages (10) will prevent damage to the blades (90) of the rotors if the UAV is blown into a building by a strong gust of wind. They will also prevent the blades (90) of the rotors from coming into contact with overhead power lines or other obstacles. The at least one electric motor (20) is preferably equipped with electronic brake systems that are active while the craft is powered. In the event of a power failure (or manual trigger) the brakes will stop the blades (90) of the rotors, thereby removing the likelihood of the spinning blades (90) striking the ground in the event of a crash, and causing personal or property damage. The motor joints (30) are designed to break away from the craft in the event of an impact, helping to absorb the force of the impact. Additionally, the present invention may be equipped with a conventional airbag system, which will deploy to protect the main body from damage in the event of a crash. It is envisioned that the airbag would preferably envelope the entirety of the present invention in the event of a collision or crash.

The avionic systems of the present invention are similar to those that conventional UAV crafts employ. The present invention is designed to be easily controlled from the ground via a remote control. This remote control may be built into a terminal station, such as at the base or interior of the command and control unit. The avionics package of the present invention is preferably outfitted to control the steering, thrust, pitch, and yaw. All of these functions can be directed to be handled automatically, directed by a wireless controller in an individual's hands or, via a computer on the ground.

The fuel powering the UAV (120) is preferably electricity, and is delivered via conventional power cables contained within the tether (50). The electricity preferably powers the sensor array (60), at least one electric motor (20), and potentially, at least one directional servo motor. The present invention may employ at least one directional servo motor in order to direct or make fine tuned adjustments to the angle of the at least one electric motor (20). The at least one directional servo motor is preferably placed on or near the motor joints (30). It is envisioned that the present invention may include a lighting system designed to illuminate the ground or other building or object ablaze. The illumination will aide the operator of the UAV (120) located on the ground, as the hose nozzle (70) is directed at the fire. It is similarly envisioned that the present invention may employ the thermal sensors held within the sensor array (60) preferably located at the front of the UAV (120), to assist the operator. The thermal sensors found within the sensor array (60) may be arranged such that they automatically guide the hose nozzle (70) of the UAV (120) to the optimal target at the foundation of the flame.

Alternate embodiments of the present invention feature, variations on the number and/or distribution of the electric motors employed to keep the UAV aloft. Similarly, the electricity supplied from ground based sources may be augmented by solar panels placed on the body of the UAV (120) itself. Similarly, in alternate embodiments of the present invention, it can be envisioned that the hose nozzle (70) may be positioned such that it ideally remains primarily fixed in a position perpendicular to the ground. In this embodiment, the ‘recoil’ force presented by water escaping the hose nozzle (70) is then used to augment the electric motors (20) maintaining the craft aloft. Conventional gyroscopes are employed within the body (130) of the present invention to maintain stability in this alternate embodiment of the present invention as well.

Ideally, all embodiments of the present invention are envisioned to be kept below 500 pounds, ensuring that the UAV (120) remains lightweight enough to remain aloft without requiring excessive amounts of power. It is envisioned that, in alternate embodiments of the present invention, the body of the UAV (120) may be equipped with solar panels, preferably affixed to the top of the UAV (120), in order to augment the electric power required to keep the UAV (120) aloft. Solar panels may also be affixed to the command and control unit in order to further augment the electricity requirements of the at least one electric motor (20), sensor array (60), and other systems of the UAV (120).

I claim:

1. An unmanned aerial vehicle designed to extinguish fires, comprising:
a body;
a motor;
a rotor;
a sensor array;
a command and control unit; and
a tether.

2. The unmanned aerial vehicle of claim 1, wherein said tether has an electrical supply.

3. The unmanned aerial vehicle of claim 1, wherein said tether has an water supply.

4. The unmanned aerial vehicle of claim 1, wherein said tether is configured to connect to a fire truck.

5. The unmanned aerial vehicle of claim 1, further comprising:
a sensory array in communication with said body.

6. The unmanned aerial vehicle of claim 1, further comprising:
a camera in communication with said body.

7. The unmanned aerial vehicle of claim 2, further comprising:
a gyroscope in communication with said body.

8. The unmanned aerial vehicle of claim 2, wherein said tether has an water supply.

9. The unmanned aerial vehicle of claim 2, wherein said tether is configured to connect to a fire truck.

10. The unmanned aerial vehicle of claim 2, further comprising:
a sensory array in communication with said body.

11. The unmanned aerial vehicle of claim 2, further comprising:
a camera in communication with said body.

12. The unmanned aerial vehicle of claim 2, further comprising:
a gyroscope in communication with said body.

13. The unmanned aerial vehicle of claim 3, wherein said tether is configured to connect to a fire truck.

14. The unmanned aerial vehicle of claim 3, further comprising:
a sensory array in communication with said body.

15. The unmanned aerial vehicle of claim 3, further comprising:
a camera in communication with said body.

16. The unmanned aerial vehicle of claim 3, further comprising:
a gyroscope in communication with said body.

17. The unmanned aerial vehicle of claim 4, further comprising:
a sensory array in communication with said body.

18. The unmanned aerial vehicle of claim 4, further comprising:
a camera in communication with said body.

19. The unmanned aerial vehicle of claim 4, further comprising:
a gyroscope in communication with said body.

20. The unmanned aerial vehicle of claim 5, further comprising:
a camera in communication with said body.
